(19) United States
(12) Patent Application Publication
(10) Pub. No.: US 2026/0163594 A1
(43) Pub. Date: Jun. 11, 2026

(54) CASCADED RADIO FREQUENCY DEVICES AND METHODS FOR OPERATING AND MANUFACTURING THEREOF

(71) Applicant: Infineon Technologies AG, Neubiberg (DE)

(72) Inventors: Philipp SCHERZ, Traun (AT); Josef KULMER, Graz (AT); Markus TREML, Altmuenster (AT); Alexander POLIN, Linz (AT)

(21) Appl. No.: 19/327,589

(22) Filed: Sep. 12, 2025

(30) Foreign Application Priority Data
Sep. 30, 2024 (DE) 102024209548.6

(51) Int. Cl. H04B 1/04

(52) U.S. Cl. CPC H04B 1/04

(57) ABSTRACT

A cascaded radio frequency (RF) device includes a first RF chip including a first local oscillator configured to generate and output a first local oscillator signal during an operation time interval, a second RF chip including a second local oscillator configured to generate and output a second local oscillator signal during the operation time interval, and a power combiner configured to combine the first local oscillator signal and the second local oscillator signal to a combined local oscillator signal and to output the combined local oscillator signal to an input of the first RF chip and to an input of the second RF chip, wherein the first local oscillator signal and the second local oscillator signal have a same frequency behavior during the operation time interval.

### CROSS-REFERENCE TO RELATED APPLICATION

This application claims priority to Germany Patent Application No. 102024209548.6 filed on Sep. 30, 2024, the content of which is incorporated by reference herein in its entirety.

### TECHNICAL FIELD

The present disclosure relates to cascaded radio frequency (RF) devices and methods for operating and manufacturing cascaded RF devices.

### BACKGROUND

In order to increase an angular resolution of radar sensors, the number of transmit and receive channels may be increased for achieving a larger aperture. A higher number of channels may be realized by cascading multiple radar MMICs (Monolithic Microwave Integrated Circuits), wherein a primary MMIC may supply the remaining secondary MMICs and itself with a common local oscillator signal. A guaranteed minimum output power of the primary local oscillator signal and a required minimum input power at the secondary MMICs may limit the maximum number of MMICs and a maximum possible distance between the MMICs on a printed circuit board (PCB) holding the MMICs. In addition, for cost reasons oftentimes only inexpensive PCB laminates may be used which may generally cause a higher attenuation of local oscillator signals. As a result, a use of inexpensive PCB laminates may be limited, as the necessary length of the local oscillator signal oftentimes cannot be achieved.

Manufacturers and developers of RF devices are constantly striving to improve their products. In the above context, it may be desirable to provide cascaded RF devices with improved performance at lower cost such that the above identified issues may at least partially be addressed. In addition, it may be desirable to provide suitable methods for operating and manufacturing such cascaded RF devices.

### SUMMARY

An aspect of the present disclosure relates to a cascaded radio frequency (RF) device. The cascaded RF device comprises a first RF chip comprising a first local oscillator configured to generate and output a first local oscillator signal during an operation time interval. The cascaded RF device further comprises a second RF chip comprising a second local oscillator configured to generate and output a second local oscillator signal during the operation time interval. The cascaded RF device further comprises a power combiner configured to combine the first local oscillator signal and the second local oscillator signal to a combined local oscillator signal and to output the combined local oscillator signal to an input of the first RF chip and to an input of the second RF chip. The first local oscillator signal and the second local oscillator signal have a same frequency behavior during the operation time interval.

A further aspect of the present disclosure relates to a method for operating a cascaded RF device. The method comprises an act of generating and outputting, by a first local oscillator of a first RF chip, a first local oscillator signal during an operation time interval. The method further comprises an act of generating and outputting, by a second local oscillator of a second RF chip, a second local oscillator signal during the operation time interval. The method further comprises an act of combining, by a power combiner, the first local oscillator signal and the second local oscillator signal to a combined local oscillator signal. The method further comprises an act of outputting, by the power combiner, the combined local oscillator signal to an input of the first RF chip and to an input of the second RF chip. The first local oscillator signal and the second local oscillator signal have a same frequency behavior during the operation time interval.

A further aspect of the present disclosure relates to a method for manufacturing a cascaded RF device. The method comprises an act of arranging a first RF chip comprising a first local oscillator configured to generate and output a first local oscillator signal during an operation time interval. The method further comprises an act of arranging a second RF chip comprising a second local oscillator configured to generate and output a second local oscillator signal during the operation time interval. The method further comprises an act of arranging a power combiner configured to combine the first local oscillator signal and the second local oscillator signal to a combined local oscillator signal and to output the combined local oscillator signal to an input of the first RF chip and to an input of the second RF chip. The first local oscillator signal and the second local oscillator signal have a same frequency behavior during the operation time interval.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 schematically illustrates a cascaded RF device 100 in accordance with the disclosure.

FIG. 2 schematically illustrates a cascaded RF device 200.

FIG. 3 illustrates a flowchart of a method for operating a cascaded RF device in accordance with the disclosure.

FIG. 4 illustrates a flowchart of a method for manufacturing a cascaded RF device in accordance with the disclosure.

### DETAILED DESCRIPTION

In the following detailed description, reference is made to the accompanying drawings, in which are shown by way of illustration specific aspects in which the disclosure may be practiced. Other aspects may be utilized and structural or logical changes may be made without departing from the concept of the present disclosure. Hence, the following detailed description is not to be taken in a limiting sense, and the concept of the present disclosure is defined by the appended claims.

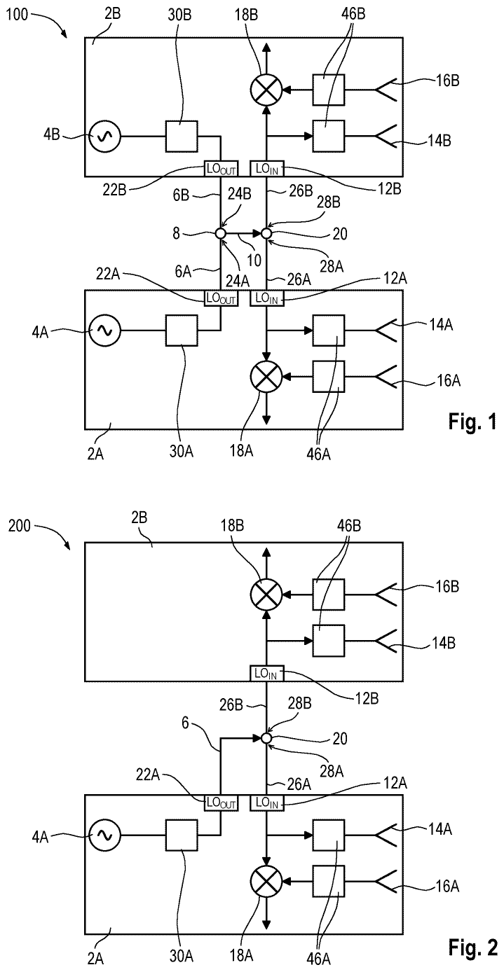

Referring now to FIG. 1, a schematic illustration of a cascaded radio frequency (RF) device (or system) 100 in accordance with the disclosure is shown. The RF device 100 may include a first RF chip 2A with a first local oscillator 4A. The first local oscillator 4A may be configured to generate and output a first local oscillator signal 6A during an operation time interval. The RF device 100 may further include a second RF chip 2B with a second local oscillator 4B. The second local oscillator 4B may be configured to generate and output a second local oscillator signal 6B during the operation time interval. The first local oscillator signal 6A and the second local oscillator signal 6B may have a same frequency behavior during the operation time interval. The RF device 100 may further include a power combiner 8 configured to combine the first local oscillator signal 6A and the second local oscillator signal 6B to a combined local oscillator signal 10 and to output the combined local oscillator signal 10 to an input 12A of the first RF chip 2A and to an input 12B of the second RF chip 2B. The RF device 100 may optionally include a power splitter 20, the function of which will be discussed later on.

In the following, features of the first RF chip 2A are specified. It is to be noted that the second RF chip 2B may include some or all of the specified features of the first RF chip 2A. In examples, the first RF chip 2A and the second RF chip 2B may have the same chip design and/or the same specifications. It is to be understood that the RF device 100 may include additional RF chips, the number of which may depend on the specific design of the RF device 100. The first RF chip 2A may be made of or may include an arbitrary semiconductor material, such as e.g., silicon. The first RF chip 2A (or electronic circuits thereof) may be configured to operate in a frequency range of greater than about 1 GHz, in some examples greater than about 10 GHz. Accordingly, the first RF chip 2A may also be referred to as radio frequency chip or high frequency chip or microwave frequency chip. More particular, the first RF chip 2A may be configured to operate in an RF range or microwave frequency range, which may range from about 1 GHz to about 1 THz, more particular from about 10 GHz to about 300 GHz. Microwave circuits may include, for example, microwave transmitters, microwave receivers, microwave transceivers, microwave sensors, microwave detectors, or the like. RF devices in accordance with the disclosure may be used for radar applications in which the frequency of the RF signals may be modulated. The first RF chip 2A may therefore also be referred to as radar chip. In particular, the first RF chip 2A may include or may correspond to an MMIC (Monolithic Microwave Integrated Circuit).

Radar microwave devices may e.g., be used in automotive, industrial, military and/or defense applications for range and speed measuring systems. For example, automotive applications may include advanced driver assistant systems, automatic vehicle cruise control systems, vehicle anti-collision systems, or the like. Such systems may operate in the microwave frequency range and may utilize FMCW (Frequency Modulation Continuous Wave) signals, for example in the 24 GHz, 76 GHz, or 79 GHz frequency bands. A use of radar microwave systems may provide constant and efficient driving of vehicles. An efficient driving style may, for example, reduce fuel consumption such that CO₂ emission may be reduced and energy savings may be enabled. In addition, abrasion of vehicle tires, brake discs and brake pads may be reduced, thereby reducing fine dust pollution. Improved RF or radar systems, as described herein, may thus contribute to green technology solutions, e.g., climate-friendly solutions providing reduced energy usage.

In some examples, the first RF chip 2A may include at least one transmit (TX) channel configured to transmit RF signals via a TX antenna 14A. In some examples, the first RF chip 2A may include at least one receive (RX) channel configured to receive RF signals via an RX antenna 16A. In some examples, the first RF chip 2A may include at least one transmit (TX) and one receive (RX) channel which may be referred to as transceiver (TRX) chip. In the illustrated example, one TX antenna 14A and one RX antenna 16A are shown for the sake of simplicity. It is to be understood that in further examples, the first RF chip 2A may include a different number of TX antennas 14A and/or RX antennas 16A which may depend on the specific design of the RF device 100. In a non-limiting example, the first RF chip 2A may include four TX antennas 14A (or four TX channels) and four RX antennas 16A (or four RX channels).

The first RF chip 2A and the second RF chip 2B may be interconnected and cascaded to form a cascaded RF system. In examples, the first RF chip 2A and the second RF chip 2B may be arranged on a same printed circuit board (PCB). The power combiner 8 and/or the power splitter 20 may be arranged on the PCB as well. Cascading multiple transceiver RF chips may enhance the number of transmit and receive channels and may therefore increase a number of virtual antenna array elements, thereby improving target detection and target resolution, which may be required by certain applications, such as e.g., L4 and L5 autonomous driving. The RF chips 2A and 2B may be synchronized in order to make the cascaded RF system 100 operate as a single RF system in which each of the RF channels may have a predefined phase relation to each other. For achieving appropriate synchronization between the RF chips 2A and 2B, specific signals may be shared between the first RF chip 2A and the second RF chip 2B. In this regard, the combined local oscillator signal 10 may be shared between the first RF chip 2A and the second RF chip 2B. In other words, both RF chips 2A and 2B may use the combined local oscillator signal 10 for operations such as transmitting signals or mixing with received signals. For example, the combined local oscillator signal 10 may be mixed with an RF signal received via the receive antenna 16A using a mixer 18A to down-convert the frequency of the received RF signal to a more manageable range. In particular, an incoming RF signal from the receive antenna 16A may be mixed with the combined local oscillator signal 10 in order to produce an intermediate (IF) frequency signal. The combined local oscillator signal 10 may be used to shift the frequency of the received RF signal to a frequency range that can be easily processed by the receiver and subsequent processing stages of the RF device 100. The combined local oscillator signal 10 may be or may include a mm-wave LO signal. In some applications, the combined local oscillator signal 10 may be or may include an FMCW-signal including a plurality of frequency ramps.

As previously mentioned, the first local oscillator signal 6A and the second local oscillator signal 6B may have a same frequency behavior during an operation time interval. The frequency behavior of a signal may specify or may refer to the way a signal changes or varies in terms of its frequency or frequency content over time. In other words, it may describe how the signal's frequency components evolve or shift as a function of time. In examples, the frequency behavior of the local oscillator signals 6A and 6B may include one or multiple frequency ramps having a start frequency and a stop frequency during the operation time interval which is the same for both local oscillator signals 6A and 6B. In particular, the first local oscillator 4A and the second local oscillator 4B may be controlled to generate and output a same local oscillator signal. That is, possible differences between the first local oscillator signal 6A and the second oscillator signal 6B may be unintentional and may, for example, result from tolerances or inaccuracies during a fabrication of the RF device 100 or its components. In examples, having a same frequency behavior may include that the first local oscillator signal 6A and the second local oscillator signal 6B may have different amplitudes. In examples, having a same frequency behavior may include that the first local oscillator signal 6A and the second local oscillator signal 6B may be the same except for a phase difference. In particular, the phase difference between the first local oscillator signal 6A and the second local oscillator signal 6B may be constant. For example, the constant phase difference may be smaller than about π/3 or smaller than about π/4 or smaller than about π/5 or smaller than about π/6 or smaller than about π/7 or smaller than about π/8. The generation of the first local oscillator signal 6A may be independent of the generation of the second local oscillator signal 6B and vice versa. This can also be seen from FIG. 1, where the first local oscillator 4A does not receive any input from the second local oscillator 4B and vice versa.

The first local oscillator signal 6A and the second local oscillator signal 6B may be based on a same reference clock. In this regard, the RF device 100 may include at least one of a local oscillator or a crystal oscillator (not illustrated) configured to generate the reference clock and to provide the reference clock to the first RF chip 2A and to the second RF chip 2B. In a first example, a local oscillator and/or crystal oscillator may be arranged external to the first RF chip 2A and external to the second RF chip 2B. In a further example, a local oscillator and/or crystal oscillator may be arranged or included in the first RF chip 2A. In general, a frequency of the first local oscillator signal 6A and/or a frequency of the second local oscillator signal 6B may be greater than a frequency of the reference clock. More particular, a frequency of the first local oscillator signal 6A and/or a frequency of the second local oscillator signal 6B may be a factor from about 102 to about 104 higher than a frequency of the reference clock. In a non-limiting and example case, the reference clock may have a frequency of about 50 MHz.

By combining the first local oscillator signal 6A and the second local oscillator signal 6B to the combined local oscillator signal 10, a local oscillator signal power may be increased. That is, a signal power of the combined local oscillator signal 10 may be greater than a signal power of the first local oscillator signal 6A and greater than a signal power of the second local oscillator signal 6B. In one example, if the first local oscillator signal 6A and the second local oscillator signal 6B are combined in phase, the signal power of the combined local oscillator signal 10 may increase by a value of about +6 dB. For this purpose, signal paths from the RF chips 2A and 2B to the power combiner 8 should be of a same length in order to ensure a smallest possible phase difference. In this context, the RF device 100 may include a first signal path to transfer the first local oscillator signal 6A from a local oscillator output 22A of the first RF chip 2A to a first local oscillator input 24A of the power combiner 8 and a second signal path to transfer the second local oscillator signal 6B from a local oscillator output 22B of the second RF chip 2B to a second local oscillator input 24B of the power combiner 8. In examples, the signal paths may extend on a PCB on which the RF chips 2A and 2B may be mounted. In order to provide a smallest possible phase difference between the first local oscillator signal 6A and the second local oscillator signal 6B at the inputs 24A and 24B of the combiner 8, a length of the first signal path and a length of the second signal path should be similar or the same.

In some examples, achieving the smallest possible phase difference between the first local oscillator signal 6A and the second local oscillator signal 6B at the inputs 24A and 24B of the combiner 8 may be problematic. In such case, at least one of the first RF chip 2A or the second RF chip 2B may include a phase shifter arranged between the local oscillator and the local oscillator output of the respective RF chip. In the illustrated example, the first RF chip 2A may include a first phase shifter 30A and the second RF chip 2B may include a second phase shifter 30B. The phase shifter(s) may be configured to compensate a phase difference between the first local oscillator signal 6A and the second local oscillator signal 6B. In a non-limiting example, a phase shifter may include or may correspond to an IQ modulator.

In the illustrated example, the RF device 100 may optionally include a power splitter 20 which may be coupled to the power combiner 8 and may be configured to split the combined local oscillator signal 10 received from the power combiner 8 into a first split local oscillator signal 26A for the first RF chip 2A and a second split local oscillator signal 26B for the second RF chip 2B. The RF device 100 may include a third signal path to transfer the first split local oscillator signal 26A from an output 28A of the power splitter 20 to the input 12A of the first RF chip 2 and a fourth signal path to transfer the second split local oscillator signal 26B from an output 28B of the power splitter 20 to the input 12B of the second RF chip 2B. In particular, a length of the third signal path and a length of the fourth signal path may be the same. Due to same lengths of the third signal path and the fourth signal path, each of the first RF chip 2A and the second RF chip 2B may receive a same local oscillator signal from the power splitter 20 such that an operation of the first RF chip 2A and the second RF chip 2B may be based on the same local oscillator signal. In particular, the same local oscillator signal may be received at the RF inputs 12A and 12B of the RF chips 2A and 2B with a same phase such that coherence between the RF chips 2A and 2B may be provided. For example, it may thus be possible for all RX channels to convert down received signals with the same phase from RF to baseband. Furthermore, since a length of the local oscillator signal distribution may be the same for each RF chip, temperature effects may affect each RF chip in a same manner, thereby reducing phase variations due to temperature variations.

It is to be noted that the power splitter 20 of the RF device 100 may be seen as optional. In a further example, the RF device 100 may not necessarily include the power splitter 20 and the combined local oscillator signal 10 may be transferred directly from the power combiner 8 to the inputs 12A and 12B of the RF chips 2A and 2B. Similar to examples including the power splitter 20, signal path lengths between the power combiner 8 and the RF chips 2A and 2B may be chosen to provide smallest possible phase differences. In this connection, the RF device 100 may include a first signal path to transfer the first local oscillator signal 6A from the local oscillator output 22A of the first RF chip 2A to the first local oscillator input 24A of the power combiner 8, a second signal path to transfer the second local oscillator signal 6B from the local oscillator output 22B of the second RF chip 2B to the second local oscillator input 24B of the power combiner 8, a third signal path to transfer the combined local oscillator signal 10 from the power combiner 8 to the input 12A of the first RF chip 2A, and a fourth signal path to transfer the combined local oscillator signal 10 from the power combiner 8 to the input 12B of the second RF chip 2B. The power combiner 8, the first signal path, the second signal path, the third signal path and the fourth signal path may be configured such that a phase of the combined local oscillator signal 10 at the input 12A of the first RF chip 2A may be the same as a phase of the combined local oscillator signal 10 at the input 12B of the second RF chip 2B. For example, at least one of an internal structure of the power combiner 8, a length of the first signal path, a length of the second signal path, a length of the third signal path, a length of the fourth signal path, or a relative arrangement between the RF chips 2A, 2B and the power combiner 8 may be adjusted or chosen in order to obtain similarity or equality of the phases.

As previously mentioned, in examples, the first RF chip 2A, the second RF chip 2B, the power combiner 8 and the power splitter 20 may be arranged on a same PCB (or PCB laminate). In further examples, the first RF chip 2A, the second RF chip 2B, the power combiner 8 and the power splitter 20 may be integrated in a same semiconductor package. In this context, a substrate may be integrated in the semiconductor package, wherein the mentioned components (and also the signal paths coupling these components as previously discussed) may be arranged on the substrate. The RF device 100 may thus include or may correspond to a multi-chip package. A multi-chip package may be seen as a collective assembly of multiple separate semiconductor chips (or semiconductor dies) and other optional electronic components. In some examples, encapsulating or molding the multiple semiconductor chips together and forming electrical redistributions may be part of forming a multi-chip package. A package may provide means for connecting the semiconductor package to its external environment (e.g., a printed circuit board (PCB)) via suitable electrical connection elements (e.g., leads, pads, balls, pins, or the like). Accordingly, the RF device 100 implemented in form of a multi-chip package may include at least one external connection element (not illustrated) configured to mechanically and electrically couple the multi-chip package to e.g., a PCB (not illustrated). Furthermore, a package may optionally provide means for protecting its components against threats, such as e.g., mechanical impact, chemical contamination, moisture, light exposure, or the like. In this regard, the RF device 100 implemented in form of a multi-chip package may include a chip package housing, wherein the first RF chip 2A, the second RF chip 2B, the power combiner 8, the power splitter 20 and the signal paths electrically coupling these components may be encapsulated in the chip package housing.

In the example of FIG. 1, an example number of two RF chips 2A and 2B are shown for the sake of simplicity. However, it is to be understood that the RF device 100 may include additional RF chips, the number and arrangement of which may depend on the specific design of the RF device 100. Such additional RF chips may include some or all features of the RF chips 2A and 2B as previously described. In examples, the power combiner 8 may be configured to provide the combined local oscillator signal 10 to at least one of the additional RF chips of the RF device 100. Alternatively, or additionally, local oscillator signals provided by local oscillators of additional RF chips may also be used for generating a combined local oscillator signal. In particular, the RF device 100 may include a third RF chip (not illustrated) including a third local oscillator configured to generate and output a third local oscillator signal during the operation time interval. The first local oscillator signal 6A, the second local oscillator signal 6B and the third local oscillator signal may have a same frequency behavior during the operation time interval. The power combiner 8 may be configured to combine the first local oscillator signal 6A, the second local oscillator signal 6B and the third local oscillator signal to a combined local oscillator signal and to output the combined local oscillator signal to an input of the first RF chip 2A, to an input of the second RF chip 2B and to an input of the third RF chip.

It is to be noted that the RF device 100 may include additional components which are not shown in FIG. 1 for the sake of simplicity. For example, the RF device 100 may include a 3D waveguide antenna which may be coupled to at least one of the first RF chip 2A or the second RF chip 2B. Furthermore, the RF chips 2A and 2B may include additional electronic circuitry 46A and 46B, e.g., for processing transmit and/or receive RF signals in an analog and/or digital domain. For the sake of simplicity, details of the additional electronic circuitry 46A and 46B are not explicitly shown and discussed in connection with the example of FIG. 1.

The cascaded RF device 100 of FIG. 1 may outperform other cascaded RF devices in various ways. An example other cascaded RF device 200 is schematically illustrated in FIG. 2. The RF device 200 may have similar components as previously described in connection with FIG. 1. In the example of FIG. 2, a local oscillator 4A of a first RF chip 2A may generate and output a local oscillator signal 6 at an local oscillator output 22A of the first RF chip 2A. A power splitter 20 may be configured to split the local oscillator signal 6 received from the first RF chip 2A into a first split local oscillator signal 26A for the first RF chip 2A and a second split local oscillator signal 26B for the second RF chip 2B. That is, the local oscillator signal 6 generated by the first RF chip 2A is provided to itself via self-feeding and to the second RF chip 2B. In examples, the first RF chip 2A may be referred to as primary RF chip (or master) while the second RF chip 2B may be referred to as secondary RF chip (or slave). The RF device 200 does not include a power combiner configured to combine local oscillator signals from both RF chips 2A and 2B to a combined local oscillator signal which may be input to and used by both RF chips 2A and 2B.

The RF device 100 of FIG. 1 may outperform the RF device 200 of FIG. 2 in that it may provide an increased signal power of the local oscillator signal. A signal power of the combined local oscillator signal 10 in FIG. 1 may be higher than a signal power of the local oscillator signal 6 in FIG. 2. If the first local oscillator signal 6A and the second local oscillator signal 6B are combined in phase, the signal power of the combined local oscillator signal 10 may increase by a value of about +6 dB. Even in case of a phase difference between the local oscillator signals 6A and 6B, a signal power may be increased when combining the local oscillator signals 6A and 6B as shown and described in connection with FIG. 1. For example, a phase difference between the local oscillator signals 6A and 6B at the power combiner 8 of about 40 degrees may still result in an increase of signal power of about +5.5 dB. That is, even in case of a phase difference of about 40 degrees, a signal power of the combined local oscillator signal 10 may still be about +5.5 dB higher than if only one RF chip provides a local oscillator signal as shown in FIG. 2. Since in the example of FIG. 1 both RF chips 2A and 2B may generate and output a respective local oscillator signal, each of the RF chips 2A and 2B may be programmed to operate as a primary RF chip of the RF device 100. That is, in the example of FIG. 1, the RF chips 2A and 2B are not necessarily distinguished in primary and secondary RF chips. It is to be understood that the RF device 100 may include additional secondary RF chips that may receive the combined local oscillator signal 10 for operational purposes, but which may not necessarily contribute to the generation of the combined local oscillator signal 10.

In the example of FIG. 2, a guaranteed minimum output power of the primary local oscillator signal 6 and a required minimum input power at the input 12A of the secondary RF chip 2B may limit the maximum number of RF chips used in the device 200 and also a maximum possible distance between the RF chips. Furthermore, using inexpensive PCB laminates may cause a higher attenuation of the local oscillator signal. In contrast to this, the device 200 of FIG. 2 may provide an increased signal power of the local oscillator signal as previously discussed. In this way, the local oscillator power budget between the RF chips of the device 200 may be improved, allowing the use of less expensive PCB laminates and/or a higher number of RF chips in the RF device 100.

The RF device 100 of FIG. 1 may outperform the RF device 200 of FIG. 2 in that it may reduce phase noise. When combining the first local oscillator signal 6A and the second local oscillator signal 6B to the combined local oscillator signal 10, a relative increase in signal power may be greater than a relative increase in phase noise. As previously discussed, in the case of combining two local oscillator signals 6A and 6B, the signal power of the combined local oscillator signal 10 may increase by a value of up to about +6 dB. At the same time, the phase noise of the combined local oscillator signal 10 may only be increased by a value of about +3 dB. Accordingly, combining the local oscillator signals 6A and 6B may result in a phase noise improvement of about −3 dB.

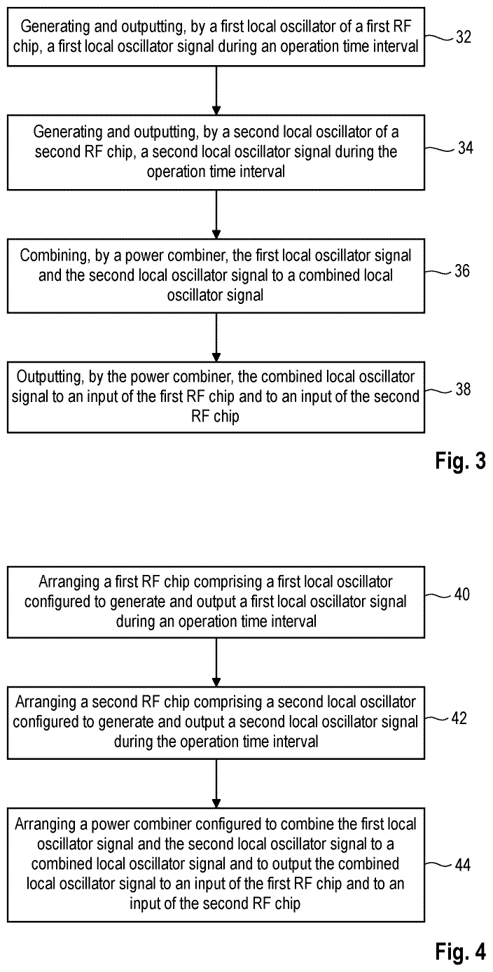

FIG. 3 illustrates a flowchart of a method for operating a cascaded RF device in accordance with the disclosure. The method may be used for operating cascaded RF devices as previously described and may thus be read in connection with previous figures. The method of FIG. 3 is described in a general manner in order to qualitatively specify aspects of the disclosure. It is to be understood that the method may include further aspects. For example, the method may be extended by any of the aspects described in connection with other examples in accordance with the disclosure.

At 32, a first local oscillator signal may be generated and output during an operation time interval by a first local oscillator of a first RF chip. At 34, a second local oscillator signal may be generated and output during the operation time interval by a second local oscillator of a second RF chip. At 36, the first local oscillator signal and the second local oscillator signal may be combined to a combined local oscillator signal by a power combiner. At 38, the combined local oscillator signal may be output to an input of the first RF chip and to an input of the second RF chip by the power combiner. The first local oscillator signal and the second local oscillator signal may have a same frequency behavior during the operation time interval.

FIG. 4 illustrates a flowchart of a method for manufacturing a cascaded RF device in accordance with the disclosure. The method may be used for manufacturing cascaded RF devices as previously described and may thus be read in connection with previous figures. The method of FIG. 4 is described in a general manner in order to qualitatively specify aspects of the disclosure. It is to be understood that the method may include further aspects. For example, the method may be extended by any of the aspects described in connection with other examples in accordance with the disclosure.

At 40, a first RF chip including a first local oscillator configured to generate and output a first local oscillator signal during an operation time interval may be arranged. At 42, a second RF chip including a second local oscillator configured to generate and output a second local oscillator signal during the operation time interval may be arranged. At 44, a power combiner configured to combine the first local oscillator signal and the second local oscillator signal to a combined local oscillator signal and to output the combined local oscillator signal to an input of the first RF chip and to an input of the second RF chip may be arranged. The first local oscillator signal and the second local oscillator signal may have a same frequency behavior during the operation time interval.

### EXAMPLES

The examples described herein provide cascaded RF devices and methods for operating and manufacturing cascaded RF devices.

Example 1 is a cascaded radio frequency (RF) device, comprising: a first RF chip comprising a first local oscillator configured to generate and output a first local oscillator signal during an operation time interval; a second RF chip comprising a second local oscillator configured to generate and output a second local oscillator signal during the operation time interval; and a power combiner configured to combine the first local oscillator signal and the second local oscillator signal to a combined local oscillator signal and to output the combined local oscillator signal to an input of the first RF chip and to an input of the second RF chip, wherein the first local oscillator signal and the second local oscillator signal have a same frequency behavior during the operation time interval.

Example 2 is a cascaded RF device according to Example 1, wherein the frequency behavior comprises a frequency ramp having a start frequency and a stop frequency during the operation time interval.

Example 3 is a cascaded RF device according to Example 1 or 2, wherein the first local oscillator and the second local oscillator are controlled to generate and output a same local oscillator signal.

Example 4 is a cascaded RF device according to any of the preceding Examples, wherein the first local oscillator signal and the second local oscillator signal are the same except for a phase difference.

Example 5 is a cascaded RF device according to any of the preceding Examples, wherein a phase difference between the first local oscillator signal and the second local oscillator signal is constant.

Example 6 is a cascaded RF device according to Example 5, wherein the constant phase difference is smaller than π/3.

Example 7 is a cascaded RF device according to any of the preceding Examples, wherein the first local oscillator signal and the second local oscillator signal are based on a same reference clock.

Example 8 is a cascaded RF device according to Example 7, further comprising: at least one of a local oscillator or a crystal oscillator arranged external to the first RF chip and external to the second RF chip and configured to generate the reference clock and to provide the reference clock to the first RF chip and to the second RF chip.

Example 9 is a cascaded RF device according to Example 7, further comprising: at least one of a local oscillator or a crystal oscillator arranged in the first RF chip and configured to generate the reference clock and to provide the reference clock to the first RF chip and to the second RF chip.

Example 10 is a cascaded RF device according to any of the preceding Examples, further comprising: a first signal path to transfer the first local oscillator signal from an output of the first RF chip to a first input of the power combiner; and a second signal path to transfer the second local oscillator signal from an output of the second RF chip to a second input of the power combiner, wherein a length of the first signal path and a length of the second signal path are the same.

Example 11 is a cascaded RF device according to any of the preceding Examples, further comprising: a first signal path to transfer the first local oscillator signal from an output of the first RF chip to a first input of the power combiner; a second signal path to transfer the second local oscillator signal from an output of the second RF chip to a second input of the power combiner; a third signal path to transfer the combined local oscillator signal from the power combiner to a first input of the first RF chip; and a fourth signal path to transfer the combined local oscillator signal from the power combiner to a second input of the second RF chip, wherein the power combiner, the first signal path, the second signal path, the third signal path and the fourth signal path are configured such that a phase of the combined local oscillator signal at the first input of the first RF chip is the same as a phase of the combined local oscillator signal at the second input of the second RF chip.

Example 12 is a cascaded RF device according to any of Examples 1 to 10, further comprising: a power splitter coupled to the power combiner and configured to split the combined local oscillator signal received from the power combiner into a first split local oscillator signal for the first RF chip and a second split local oscillator signal for the second RF chip.

Example 13 is a cascaded RF device according to Example 12, further comprising: a third signal path to transfer the first split local oscillator signal from an output of the power splitter to an input of the first RF chip; and a fourth signal path to transfer the second split local oscillator signal from an output of the power splitter to an input of the second RF chip, wherein a length of the third signal path and a length of the fourth signal path are the same.

Example 14 is a cascaded RF device according to any of the preceding Examples, wherein, when combining the first local oscillator signal and the second local oscillator signal to the combined local oscillator signal, a relative increase in signal power is greater than a relative increase in phase noise.

Example 15 is a cascaded RF device according to any of the preceding Examples, wherein: the first RF chip and the second RF chip are integrated in a same semiconductor package, and the power combiner is arranged in the semiconductor package.

Example 16 is a cascaded RF device according to any of the preceding Examples, wherein each of the first RF chip and the second RF chip is programmed to operate as a primary RF chip of the cascaded RF device.

Example 17 is a cascaded RF device according to any of the preceding Examples, wherein: at least one of the first RF chip or the second RF chip comprises a phase shifter arranged between the local oscillator and an output of the respective RF chip, and the phase shifter is configured to compensate a phase difference between the first local oscillator signal and the second local oscillator signal.

Example 18 is a cascaded RF device according to any of the preceding Examples, wherein the power combiner is configured to provide the combined local oscillator signal to a third RF chip of the cascaded RF device.

Example 19 is a cascaded RF device according to any of the preceding Examples, further comprising: a third RF chip comprising a third local oscillator configured to generate and output a third local oscillator signal during the operation time interval, wherein the power combiner is configured to combine the first local oscillator signal, the second local oscillator signal and the third local oscillator signal to a combined local oscillator signal and to output the combined local oscillator signal to an input of the first RF chip, to an input of the second RF chip and to an input of the third RF chip, wherein the first local oscillator signal, the second local oscillator signal and the third local oscillator signal have a same frequency behavior during the operation time interval.

Example 20 is a cascaded RF device according to any of the preceding Examples, further comprising: a 3D waveguide antenna coupled to at least one of the first RF chip or the second RF chip.

Example 21 is a method for operating a cascaded RF device, the method comprising: generating and outputting, by a first local oscillator of a first RF chip, a first local oscillator signal during an operation time interval; generating and outputting, by a second local oscillator of a second RF chip, a second local oscillator signal during the operation time interval; combining, by a power combiner, the first local oscillator signal and the second local oscillator signal to a combined local oscillator signal; and outputting, by the power combiner, the combined local oscillator signal to an input of the first RF chip and to an input of the second RF chip, wherein the first local oscillator signal and the second local oscillator signal have a same frequency behavior during the operation time interval.

Example 22 is a method for manufacturing a cascaded RF device, the method comprising: arranging a first RF chip comprising a first local oscillator configured to generate and output a first local oscillator signal during an operation time interval; arranging a second RF chip comprising a second local oscillator configured to generate and output a second local oscillator signal during the operation time interval; and arranging a power combiner configured to combine the first local oscillator signal and the second local oscillator signal to a combined local oscillator signal and to output the combined local oscillator signal to an input of the first RF chip and to an input of the second RF chip, wherein the first local oscillator signal and the second local oscillator signal have a same frequency behavior during the operation time interval.

As employed in this specification, the terms “connected”, “coupled”, “electrically connected”, and/or “electrically coupled” may not necessarily mean that elements must be directly connected or coupled together. Intervening elements may be provided between the “connected”, “coupled”, “electrically connected”, or “electrically coupled” elements.

Furthermore, to the extent that the terms “having”, “containing”, “including”, “with”, or variants thereof are used in either the detailed description or the claims, such terms are intended to be inclusive in a manner similar to the term “comprising”. That is, as used herein, the terms “having”, “containing”, “including”, “with”, “comprising”, and the like are open-ended terms that indicate the presence of stated elements or features, but do not preclude additional elements or features. The articles “a”, “an”, and “the” are intended to include the plural as well as the singular, unless the context clearly indicates otherwise.

Moreover, the words “example” and “example” are used herein to mean serving as an example, instance, or illustration. Any aspect or design described herein as “example” or “example” is not necessarily to be construed as advantageous over other aspects or designs. Rather, use of the words “example” and “example” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the previous instances. In addition, the articles “a” and “an” as used in this application and the appended claims may generally be construed to mean “one or multiple” unless specified otherwise or clear from context to be directed to a singular form. Also, at least one of A and B or the like generally means A or B or both A and B.

Although specific examples have been illustrated and described herein, it will be appreciated by those of ordinary skill in the art that a variety of alternate and/or equivalent implementations may be substituted for the specific examples shown and described without departing from the scope of the present implementation. This application is intended to cover any adaptations or variations of the specific examples discussed herein. Therefore, it is intended that this implementation be limited only by the claims and the equivalents thereof.

It should be noted that the methods and devices including its preferred implementations as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the implementation and are included within its spirit and scope. Furthermore, all examples and implementations outlined in the present document are principally intended expressly to be only for explanatory purposes to help the reader in understanding the principles of the proposed methods and systems. Furthermore, all statements herein providing principles, aspects, and implementations of the implementation, as well as specific examples thereof, are intended to encompass equivalents thereof.

1. A cascaded radio frequency device, comprising:
a first RF chip comprising a first local oscillator configured to generate and output a first local oscillator signalduring an operation time interval;
a second RF chip comprising a second local oscillator configured to generate and output a second local oscillator signal during the operation time interval; and
a power combiner configured to combine the first local oscillator signal and the second local oscillator signal to a combined local oscillator signal and to output the combined local oscillator signal to an input of the first RF chip and to an input of the second RF chip,
wherein the first local oscillator signal and the second local oscillator signal have a same frequency behavior during the operation time interval.

2. The cascaded RF device of claim 1, wherein the same frequency behavior comprises a frequency ramp having a start frequency and a stop frequency during the operation time interval.

3. The cascaded RF device of claim 1, wherein the first local oscillator and the second local oscillator are controlled to generate and output a same local oscillator signal.

4. The cascaded RF device of claim 1, wherein the first local oscillator signal and the second local oscillator signal are the same except for a phase difference.

5. The cascaded RF device of claim 1, wherein a phase difference between the first local oscillator signal and the second local oscillator signal is constant.

6. The cascaded RF device of claim 5, wherein the constant-phase difference is smaller than π/3.

7. The cascaded RF device of claim 1, wherein the first local oscillator signal and the second local oscillator signal are based on a same reference clock.

8. The cascaded RF device of claim 7, further comprising:
at least one of a local oscillator or a crystal oscillator arranged external to the first RF chip and external to the second RF chip and configured to generate the reference clock and to provide the reference clock to the first RF chip and to the second RF chip.

9. The cascaded RF device of claim 7, further comprising:
at least one of a local oscillator or a crystal oscillator arranged in the first RF chip and configured to generate the reference clock and to provide the reference clock to the first RF chip and to the second RF chip.

10. The cascaded RF device of claim 1, further comprising:
a first signal path to transfer the first local oscillator signal from a local oscillator output of the first RF chip to a first local oscillator input of the power combiner; and
a second signal path to transfer the second local oscillator signal from a local oscillator output of the second RF chip to a second local oscillator input of the power combiner,
wherein a length of the first signal path and a length of the second signal path are the same.

11. The cascaded RF device of claim 1, further comprising:
a first signal path to transfer the first local oscillator signal from a local oscillator output of the first RF chip to a first local oscillator input of the power combiner;
a second signal path to transfer the second local oscillator signal from a local oscillator output of the second RF chip to a second local oscillator input of the power combiner;
a third signal path to transfer the combined local oscillator signal from the power combiner to a first input of the first RF chip; and
a fourth signal path to transfer the combined local oscillator signal from the power combiner to a second input of the second RF chip,
wherein the power combiner, the first signal path, the second signal path, the third signal path and the fourth signal path are configured such that a phase of the combined local oscillator signal at the first input of the first RF chip is the same as a phase of the combined local oscillator signal at the second input of the second RF chip.

12. The cascaded RF device of claim 1, further comprising:
a power splitter coupled to the power combiner and configured to split the combined local oscillator signal received from the power combiner into a first split local oscillator signal for the first RF chip and a second split local oscillator signal for the second RF chip.

13. The cascaded RF device of claim 12, further comprising:
a third signal path to transfer the first split local oscillator signal from an output of the power splitter to an input of the first RF chip; and
a fourth signal path to transfer the second split local oscillator signal from an output of the power splitter to an input of the second RF chip,
wherein a length of the third signal path and a length of the fourth signal path are the same.

14. The cascaded RF device of claim 1, wherein, when combining the first local oscillator signal and the second local oscillator signal to the combined local oscillator signal, a relative increase in signal power is greater than a relative increase in phase noise.

15. The cascaded RF device of claim 1, wherein:
the first RF chip and the second RF chip are integrated in a same semiconductor package, and
the power combiner is arranged in the semiconductor package.

16. The cascaded RF device of claim 1, wherein each of the first RF chip and the second RF chip is programmed to operate as a primary RF chip of the cascaded RF device.

17. The cascaded RF device of claim 1, wherein:
at least one of the first RF chip or the second RF chip comprises a phase shifter arranged between the local oscillator and a local oscillator output of the respective RF chip, and
the phase shifter is configured to compensate a phase difference between the first local oscillator signal and the second local oscillator signal.

18. The cascaded RF device of claim 1, wherein the power combiner is configured to provide the combined local oscillator signal to a third RF chip of the cascaded RF device.

19. The cascaded RF device of claim 1, further comprising:
a third RF chip comprising a third local oscillator configured to generate and output a third local oscillator signal during the operation time interval,
wherein the power combiner is configured to combine the first local oscillator signal, the second local oscillator signal and the third local oscillator signal to a combined local oscillator signal and to output the combined local oscillator signal to an input of the first RF chip, to an input of the second RF chip and to an input of the third RF chip,
wherein the first local oscillator signal, the second local oscillator signal and the third local oscillator signal have a same frequency behavior during the operation time interval.

20. The cascaded RF device of claim 1, further comprising:
a 3D waveguide antenna coupled to at least one of the first RF chip or the second RF chip.

21. A method for operating a cascaded RF device, the method comprising:
generating and outputting, by a first local oscillator of a first RF chip, a first local oscillator signal during an operation time interval;
generating and outputting, by a second local oscillator of a second RF chip, a second local oscillator signal during the operation time interval;
combining, by a power combiner, the first local oscillator signal and the second local oscillator signal to a combined local oscillator signal; and
outputting, by the power combiner, the combined local oscillator signal to an input of the first RF chip and to an input of the second RF chip,
wherein the first local oscillator signal and the second local oscillator signal have a same frequency behavior during the operation time interval.

22. A method for manufacturing a cascaded RF device, the method comprising:
arranging a first RF chip comprising a first local oscillator configured to generate and output a first local oscillator signal during an operation time interval;
arranging a second RF chip comprising a second local oscillator configured to generate and output a second local oscillator signal during the operation time interval; and
arranging a power combiner configured to combine the first local oscillator signal and the second local oscillator signal to a combined local oscillator signal and to output the combined local oscillator signal to an input of the first RF chip and to an input of the second RF chip,
wherein the first local oscillator signal and the second local oscillator signal have a same frequency behavior during the operation time interval.
